(19) United States
(12) Patent Application Publication
(10) Pub. No.: US 2015/0321585 A1
(43) Pub. Date: Nov. 12, 2015

(54) Recliner Mechanism

(71) Applicant: Lear Corporation, Southfield, MI (US)

(72) Inventors: Peter Robert McCulloch, Grosse Pointe Woods, MI (US); James S. Wawrzyniak, Warren, MI (US)

(21) Appl. No.: 14/618,193

(22) Filed: Feb. 10, 2015

Related U.S. Application Data
(60) Provisional application No. 61/991,875, filed on May 12, 2014.

(51) Int. Cl. B60N 2/235; A47C 1/025

(52) U.S. Cl. CPC B60N 2/2356; A47C 1/025; B60N 2/2358

(57) ABSTRACT

A recliner mechanism having a gear plate that may be disposed between a first plate and a second plate. A first set of pawls may be configured to engage the first set of teeth on the gear plate to inhibit rotation of the gear plate with respect to the first plate. A second set of pawls may be configured to engage the second set of teeth on the gear plate to inhibit rotation of the second plate with respect to the gear plate.

### CROSS-REFERENCE TO RELATED APPLICATIONS

This application claims the benefit of U.S. Provisional Application No. 61/991,875, filed May 12, 2014, the disclosure of which is hereby incorporated in its entirety by reference herein.

### TECHNICAL FIELD

This patent application relates to a recliner mechanism that may be provided with a seat.

### BACKGROUND

A vehicle seat and recliner memory module is disclosed in U.S. Patent Publication No. 2011/0127821.

### SUMMARY

In at least one embodiment, a recliner mechanism is provided. The recliner mechanism may include a first plate, a second plate, a gear plate, a first set of pawls, and a second set of pawls. The second plate may be configured to rotate about an axis with respect to the first plate. The gear plate may be disposed between the first plate and the second plate and may be configured to rotate with respect to the first plate and the second plate. The gear plate may have a first set of teeth that may be disposed proximate the first plate and a second set of teeth that may be disposed proximate the second plate. The first set of pawls may be configured to engage the first set of teeth to inhibit rotation of the gear plate with respect to the first plate. The second set of pawls may be configured to engage the second set of teeth to inhibit rotation of the second plate with respect to the gear plate.

In at least one embodiment, a recliner mechanism is provided. The recliner mechanism may include a first plate, a second plate, a gear plate, a first set of pawls, and a second set of pawls. The second plate may be configured to rotate about an axis with respect to the first plate. The gear plate may be disposed between the first plate and the second plate and may be configured to rotate with respect to the first plate and the second plate. The gear plate may have a first set of teeth and a second set of teeth that may at least partially define a center hole of the gear plate. The first set of pawls may be received in the center hole and may be configured to engage the first set of teeth to inhibit rotation of the gear plate with respect to the first plate. The second set of pawls may be received in the center hole and may be configured to engage the second set of teeth to inhibit rotation of the second plate with respect to the gear plate. The second set of pawls may be disposed closer to the second plate than the first set of pawls.

In at least one embodiment, a recliner mechanism is provided. The recliner mechanism may include a first plate, a second plate, a gear plate, a first set of pawls, a second set of pawls, a first cam plate, and a second cam plate. The second plate may be configured to rotate about an axis with respect to the first plate. The gear plate may be disposed between the first plate and the second plate and may be configured to rotate with respect to the first plate and the second plate. The gear plate may have a first set of teeth and a second set of teeth that may at least partially define a center hole of the gear plate. The first set of pawls may be received in the center hole and may be configured to engage the first set of teeth to inhibit rotation of the gear plate with respect to the first plate. The first cam plate may be disposed in the center hole and may be configured to actuate the first set of pawls. The second set of pawls may be received in the center hole and may be configured to engage the second set of teeth to inhibit rotation of the second plate with respect to the gear plate. The second cam plate may be disposed in the center hole and may be configured to actuate the second set of pawls.

### BRIEF DESCRIPTION OF THE DRAWINGS

FIG. 1 is a perspective view of a portion of a seat assembly having a recliner mechanism.

FIG. 2 is an exploded view of the recliner mechanism.

FIG. 3 is a perspective view of a first plate of the recliner mechanism.

FIG. 4 is a perspective view of a second plate of the recliner mechanism.

FIG. 5 is a perspective view of a gear plate of the recliner mechanism.

FIG. 6 is a perspective view of a first cam of the recliner mechanism.

FIG. 7 is a perspective view of a second cam of the recliner mechanism.

FIG. 8 is a perspective view of a first pawl of the recliner mechanism.

FIG. 9 is a perspective view of a second pawl of the recliner mechanism.

FIG. 10 is a perspective view of a first cam plate of the recliner mechanism.

FIG. 11 is a perspective view of a second cam plate of the recliner mechanism.

FIG. 12 is a perspective view of a spacer cam disc of the recliner mechanism.

FIG. 13 is a perspective view of a driver of the recliner mechanism.

FIGS. 14-16 illustrate seat back dump functionality of the recliner mechanism.

FIGS. 17 and 18 illustrate recliner functionality of the recliner mechanism.

FIGS. 19 and 20 illustrate comfort stop functionality of the recliner mechanism.

FIG. 21 is a section view of the recliner mechanism and an alternative driver configuration.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

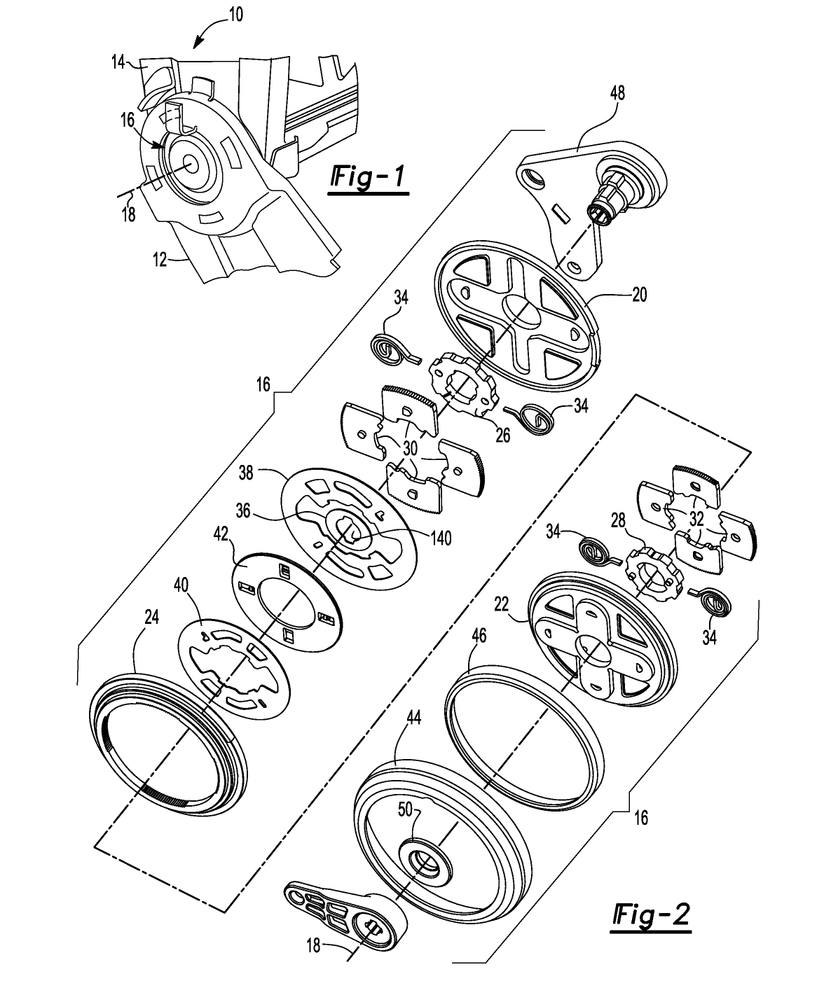

Referring to FIG. 1, a portion of a seat assembly 10 is shown. The seat assembly 10 may have a seat bottom 12, a seat back 14, and a recliner mechanism 16.

Referring to FIG. 2, an exploded view of the recliner mechanism 16 is shown. The recliner mechanism 16 may be configured to control pivoting of the seat back 14 about an axis 18 with respect to the seat bottom 12. For example, the recliner mechanism 16 may facilitate pivoting of the seat back 14 between a folded position in which the seat back 14 may be generally positioned over the seat bottom 12 through gear positions and to a reclined position. One or more recliner mechanisms 16 may be provided with the seat assembly 10. For example, a pair of recliner mechanisms 16 may be disposed along opposing lateral sides of the seat back 14 to selectively permit or inhibit pivoting of the seat back 14. A torsion rod may interconnect the recliner mechanisms and facilitate or synchronize operation of the recliner mechanisms. The recliner mechanism 16 may generally have a disc shape.

The recliner mechanism 16 may include a first plate 20, a second plate 22, a gear plate 24, a first cam 26, a second cam 28, a first set of pawls 30, a second set of pawls, 32, one or more springs 34, a cam spacer 36, a first cam plate 38, a second cam plate 40, a spacer cam disc 42, a retainer ring 44, a glide 46, a driver 48, and a cap 50.

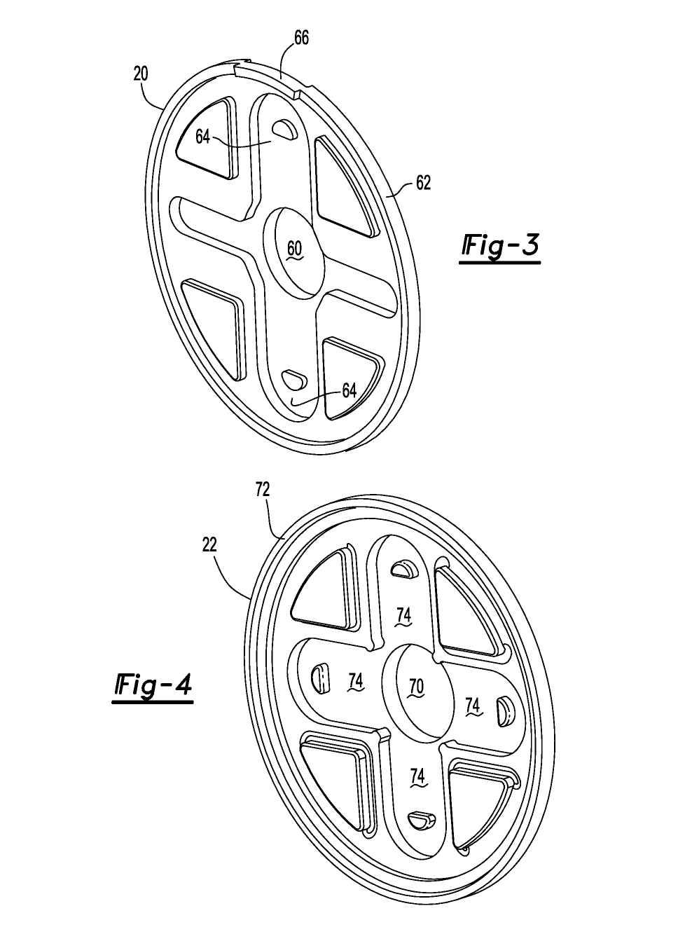

Referring to FIG. 3, the first plate 20 may be fixedly positioned on or with respect to a seat bottom 12. For example, the first plate 20 may be configured to be coupled to the seat bottom 12 via a recliner mounting bracket that may be fixedly disposed on or provided with a seat bottom frame. In at least one embodiment, the first plate 20 may be generally configured as a circular disc and may include a center hole 60, an outer surface 62, a set of spring slots 64, and a first plate stop tab 66.

The center hole 60 may be disposed proximate the center of the first plate 20. The center hole 60 may be radially disposed about the axis 18.

The outer surface 62 may be disposed opposite the center hole 60 and may face toward and may engage the retainer ring 44. In at least one embodiment, the outer surface 62 or a portion thereof may be radially disposed with respect to the axis 18 and may at least partially define an outside circumference of the first plate 20.

The set of spring slots 64 may be disposed between the center hole 60 and the outer surface 62. One or more members of the set of spring slots 64 may be configured to receive and position a spring 34 that may bias a corresponding member of the first set of pawls 30 outwardly or away from the axis 18 via the first cam 26.

The first plate stop tab 66 may be disposed proximate the outer surface 62. The first plate stop tab 66 may extend axially toward the gear plate 24 and may be configured to engage a stop tab on the gear plate 24 as will be discussed in more detail below.

Referring to FIG. 4, the second plate 22 may be configured to be coupled to the seat back 14 and may rotate about the axis 18 with respect to the first plate 20. For example, the second plate 22 may be coupled to a side member of the seat back frame or may be fixedly disposed on a recliner mounting bracket that may be coupled to the seat back frame. The second plate 22 may be completely separated from or completely spaced apart from the first plate 20 by the gear plate 24. The second plate 22 may include a center hole 70, an outer surface 72, and a set of spring slots 74.

The center hole 70 may be disposed proximate the center of the second plate 22. The center hole 70 may be radially disposed about the axis 18.

The outer surface 72 may be disposed opposite the center hole 70 and may face toward the retainer ring 44. The outer surface 72 may also engage the glide 46 and may be completely separated from the retainer ring 44 by the glide 46 in one or more embodiments. In at least one embodiment, the outer surface 72 or a portion thereof may be radially disposed with respect to the axis 18 and may at least partially define an outside circumference of the second plate 22.

The set of spring slots 74 may be disposed between the center hole 70 and the outer surface 72. One or more members of the set of spring slots 74 may be configured to receive and position a spring 34 that may bias a corresponding member of the second set of pawls 32 outwardly or away from the axis 18 via the second cam 28.

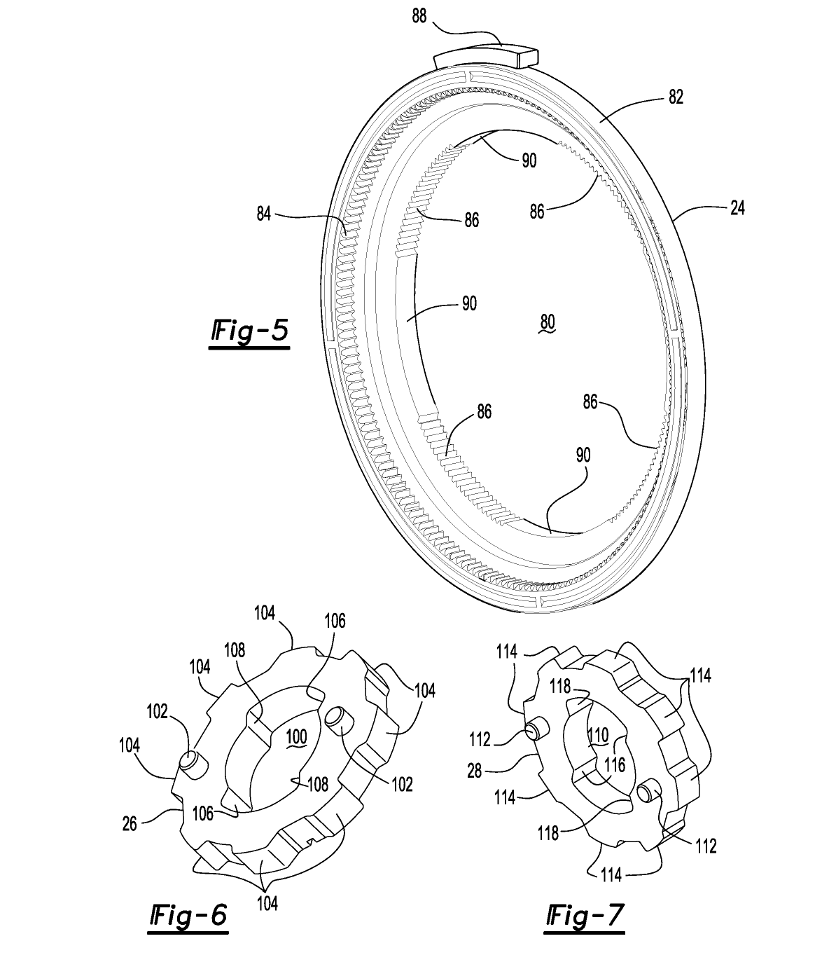

Referring to FIG. 5, the gear plate 24 may be disposed between the first plate 20 and the second plate 22. The gear plate 24 may be configured to rotate about the axis 18 with respect to the first plate 20 or the second plate 22 as will be discussed in more detail below. In at least one embodiment, the gear plate 24 may be generally configured as a circular disc and may include a center hole 80, an outer surface 82, a first set of teeth 84, a second set of teeth 86, and a gear plate stop tab 88.

The center hole 80 may be disposed proximate the center of the gear plate 24. The center hole 80 may be radially disposed about the axis 18 and may be larger than the center hole 60 of the first plate 20 and the center hole 70 of the second plate 22.

The outer surface 82 may be disposed opposite the center hole 80 and may face toward the retainer ring 44 and may be disposed proximate and may engage the first plate 20 and/or the glide 46. In at least one embodiment, the outer surface 82 or a portion thereof may be radially disposed with respect to the axis 18 and may at least partially define an outside circumference of the gear plate 24.

The first set of teeth 84 may be configured to engage the first set of pawls 30. The first set of teeth 84 may be disposed proximate a side of the gear plate 24 that faces toward the first plate 20. As such, the first set of teeth 84 may be disposed proximate the first plate 20 or closer to the first plate 20 than the second set of teeth 86. Members of the first set of teeth 84 may be disposed opposite the outer surface 82 and may extend toward the axis 18 and may at least partially define the center hole 80. In addition, members of the first set of teeth 84 may be arranged in a continuous or repeating manner around an inside circumference of the gear plate 24. As such, the first set of teeth 84 may extend continuously around the axis 18. The first set of teeth 84 may be disposed further from the axis 18 than the second set of teeth 86 and may be completely spaced apart from the second set of teeth 86.

The second set of teeth 86 may be configured to engage the second set of pawls 32. The second set of teeth 86 may be disposed proximate a side of the gear plate 24 that faces toward the second plate 22. As such, the second set of teeth 86 may be disposed proximate the second plate 22 or closer to the second plate 22 than the first set of teeth 84. Members of the second set of teeth 86 may be generally disposed opposite the outer surface 82 and may extend toward the axis 18 and may at least partially define the center hole 80. In addition, the second set of teeth 86 may be arranged closer to the axis 18 or located at a shorter radial distance from the axis 18 than the first set of teeth 84. Members of the second set of teeth 86 may be arranged in discrete subgroups that are spaced apart from each other rather than in a continuous manner around an inside circumference of the gear plate 24. For example, the second set of teeth 86 may be divided into four subgroups, which are each designated with reference number 86 in FIG. 5. Each subgroup of the second set of teeth 86 may be separated from an adjacent subgroup of the second set of teeth 86 by a separating surface 90. A separating surface 90 may be free of teeth and may be disposed at a substantially contact radial distance from the axis 18. Moreover, one or more separating surfaces 90 may be disposed closer to the axis 18 than the first set of teeth 84 and the second set of teeth 86. As such, members of the second set of pawls 32 may only lock against the gear plate 24 when aligned with a corresponding subgroup of teeth 86.

The gear plate stop tab 88 may be disposed proximate the outer surface 82. The gear plate stop tab 88 may extend axially toward the first plate 20 and may be configured to engage the first plate stop tab 66 on the first plate 20.

Referring to FIG. 6, the first cam 26 may facilitate actuation of the first set of pawls 30. The first cam 26 may be disposed in the center hole 80 of the gear plate 24 and may be configured to rotate about the axis 18. The first cam 26 may include a center hole 100, one or more pins 102, and a plurality of cam lobes 104.

The center hole 100 may be disposed proximate the axis 18. The center hole 100 may generally have a bowtie shape that may include a first side surface 106 and a second side surface 108 that may be disposed opposite the first side surface 106. The first side surface 106 and the second side surface 108 may extend radially or extend away from the axis 18 and may be selectively engaged by the driver 48 to facilitate rotation of the first cam 26 about the axis 18 as will be discussed in more detail below.

The pins 102 may extend from a side of the first cam 26 toward the first plate 20. In addition, each pin 102 may be disposed between the center hole 100 and a cam lobe 104. Each pin 102 may engage a corresponding spring 34 that may bias the first cam 26 to rotate in a manner that actuates the first set of pawls 30 away from the axis 18.

The cam lobes 104 may be provided around the periphery of the first cam 26. In FIG. 6, eight cam lobes 104 are shown. The cam lobes 104 may be disposed opposite the center hole 100, may extend away from the axis 18, and may be configured to engage and actuate the first cam plate 38, which in turn may control actuation of the first set of pawls 30, when the first cam 26 is rotated.

Referring to FIG. 7, the second cam 28 may facilitate actuation of the second set of pawls 32. The second cam 28 may be disposed in the center hole 80 of the gear plate 24 and may be configured to rotate about the axis 18. The second cam 28 may include a center hole 110, one or more pins 112, and a plurality of cam lobes 114.

The center hole 110 may be disposed proximate the axis 18. The center hole 110 may generally have a bowtie shape that may include a first side surface 116 and a second side surface 118 that may be disposed opposite the first side surface 116. The first side surface 116 and the second side surface 118 may extend away from the axis 18 and may be selectively engaged by the driver 48 to facilitate rotation of the second cam 28 about the axis 18 as will be discussed in more detail below.

The pins 112 may extend from a side of the second cam 28 toward the second plate 22. In addition, each pin 112 may be disposed between the center hole 110 and a cam lobe 114. Each pin 112 may engage a corresponding spring 34 that may bias the second cam 28 to rotate in a manner that actuates the second set of pawls 32 away from the axis 18.

The cam lobes 114 may be provided around the periphery of the second cam 28. In FIG. 7, eight cam lobes 114 are shown. The cam lobes 114 may be disposed opposite the center hole 110, may extend away from the axis 18, and may be configured to engage and actuate the second cam plate 40, which in turn may control actuation of the second set of pawls 32, when the second cam 28 is rotated.

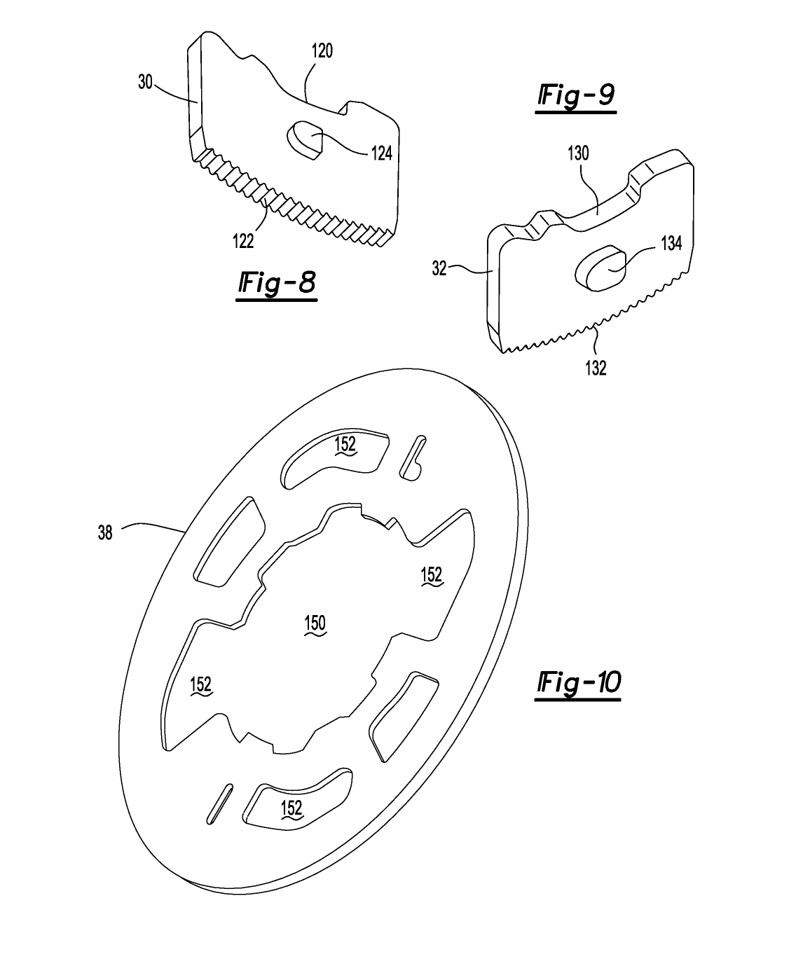

Referring to FIGS. 2 and 8, the first set of pawls 30 may be arranged around the first cam 26 with two of the pawls 30 being located adjacent to different springs 34. As such, the first set of pawls 30 may be coplanar with each other and may be disposed in a common plane with the first cam 26 that may extend substantially perpendicular to the axis 18. The first set of pawls 30 may be received in the center hole 80 of the gear plate 24. The first set of pawls 30 may be configured to selectively engage the first set of teeth 84 as will be discussed in more detail below. The pawls 30 may include a cam following edge 120 that may cooperate with the cam lobes 104 of the first cam 26 to permit the pawls 30 to move in a radial direction or substantially linearly toward/away from the axis 18 between a locking position and an unlocking position as will be more fully described below. Each pawl 30 may have an externally toothed edge 122 that may be disposed opposite the cam following edge 120. The pawls 30 may also have a pawl pin 124 that may extend away from the first plate 20 and toward the first cam plate 38.

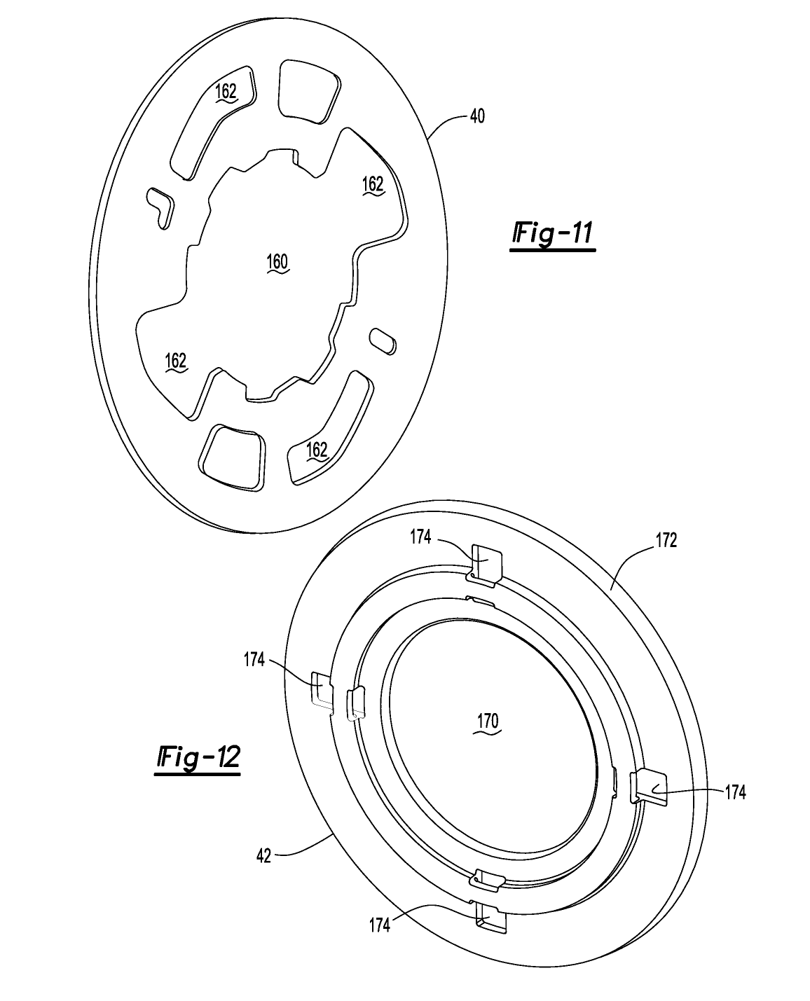

Referring to FIGS. 2 and 9, the second set of pawls 32 may have a similar configuration as the first set of pawls 30. In at least one embodiment, the second set of pawls 32 may be smaller than the first set of pawls 30 to accommodate the configuration of the gear plate 24. The second set of pawls 32 may be arranged around the second cam 28 with two of the pawls 32 being located adjacent to different springs 34. As such, the second set of pawls 32 may be coplanar with each other and may be disposed in a common plane with the second cam 28 that may extend substantially perpendicular to the axis 18. The second set of pawls 32 may be received in the center hole 80 of the gear plate 24. Moreover, the second set of pawls 32 may be axially offset from and may not be coplanar with the first set of pawls 30. For example, the first set of pawls 30 and the second set of pawls 32 may be arranged in substantially parallel planes that may be axially offset from each other (e.g., disposed at different positions along the axis 18) such that the first set of pawls 30 may be disposed closer to the first plate 20 than the second set of pawls 32 and the second set of pawls 32 may be disposed closer to the second plate 22 than the first set of pawls 30. The second set of pawls 32 may be configured to selectively engage the second set of teeth 86 as will be discussed in more detail below. The pawls 32 may include a cam following edge 130 that may cooperate with the cam lobes 114 of the second cam 28 to permit the pawls 32 to move in a radial direction or substantially linearly toward/away from the axis 18 between a memory locking position and a memory unlocking position as will be more fully described below. Each pawl 32 may have an externally toothed edge 132 that may be disposed opposite the cam following edge 130. The pawls 32 may also have a pawl pin 134 that may extend away from the second plate 22 and toward the second cam plate 40 and the spacer cam disc 42.

Referring to FIG. 2, an exemplary spring 34 is shown. The springs 34 associated with the first set of pawls 30 may be slightly larger than those associated with the second set of pawls 32.

Referring to FIG. 2, the cam spacer 36 may be disposed in the center hole 80 of the gear plate 24 between the first cam 26 and the second cam 28. As such, the cam spacer 36 may inhibit the first cam 26 from engaging the second cam 28. The cam spacer 36 may extend around the axis 18 and may be disposed substantially perpendicular to the axis 18 in one or more embodiments. The cam spacer 36 may have a cam spacer hole 140 that may be disposed along the axis 18 through which the driver 48 may extend. The cam spacer 36 may be received in the center hole 100 of the gear plate 24 and may be spaced apart from and may not engage the gear plate 24.

Referring to FIGS. 2 and 10, the first cam plate 38 may be disposed in the center hole 80 of the gear plate 24 between the first set of pawls 30 and the spacer cam disc 42 or between the first set of pawls 30 and the second set of pawls 32. The first cam plate 38 may extend around the axis 18 and may be disposed substantially perpendicular to the axis 18 in one or more embodiments. The first cam plate 38 may be configured to actuate the first set of pawls 30 when the first cam plate 38 is rotated about the axis 18 as will be discussed in more detail below. The first cam plate 38 may include a center hole 150 and a plurality of pawl actuation openings 152.

The center hole 150 may be disposed proximate the axis 18. The center hole 150 may be configured to mate with the cam lobes 104 of the first cam 26 such that the first cam plate 38 rotates with the first cam 26.

Each pawl actuation opening 152 may be configured to guide movement of a corresponding member of the first set of pawls 30 when the first cam plate 38 is rotated about the axis 18 by the first cam 26. More specifically, the pawl pin 124 of each first pawl 30 may be configured to slide within a corresponding pawl actuation opening 152 such that at least one surface that defines the pawl actuation opening 152 may exert force on the pawl pin 124 and guide movement of the pawl 30 toward or away from the axis 18. As such, each first pawl 30 may be refracted toward the axis 18 when the first cam plate 38 rotates about the axis 18 in a first direction and may be extended when the first cam plate 38 rotates about the axis 18 in a second direction that may be disposed opposite the first direction. Each pawl actuation opening 152 may become progressively closer to the axis 18 as the first cam plate 38 is rotated in the first direction. In FIG. 10, two of the pawl actuation openings 152 are contiguous with the center hole 150 and two pawl actuation openings 152 are completely spaced apart from and not contiguous with the center hole 150.

Referring to FIGS. 2 and 11, the second cam plate 40 may be disposed in the center hole 80 of the gear plate 24 between the second set of pawls 32 and the spacer cam disc 42. The second cam plate 40 may extend around the axis 18 and may be disposed substantially perpendicular to the axis 18 in one or more embodiments. In addition, the second cam plate 40 may be completely spaced apart from the first cam plate 38 and may have a smaller outside diameter than the first cam plate 38 in one or more embodiments. The second cam plate 40 may be configured to actuate the second set of pawls 32 when the second cam plate 40 is rotated about the axis 18 as will be discussed in more detail below. The second cam plate 40 may include a center hole 160 and a plurality of pawl actuation openings 162.

The center hole 160 may be disposed proximate the axis 18. The center hole 160 may be configured to mate with the cam lobes 114 of the second cam 28 such that the second cam plate 40 rotates with the first cam 26. The center hole 160 may be smaller than the center hole 150 of the first cam plate 38.

Each pawl actuation opening 162 may be configured to guide movement of a corresponding member of the second set of pawls 32 when the second cam plate 40 is rotated about the axis 18 by the second cam 28. More specifically, the pawl pin 134 of each second pawl 32 may be configured to slide within a corresponding pawl actuation opening 162 such that at least one surface that defines the pawl actuation opening 162 may exert force on the pawl pin 134 and guide movement of the pawl 32 away from the axis 18. As such, each second pawl 32 may be retracted toward the axis 18 when the second cam plate 40 rotates about the axis 18 in the second direction. Each pawl actuation opening 162 may become progressively closer to the axis 18 as the second cam plate 40 is rotated in the second direction. In FIG. 11, two of the pawl actuation openings 162 are contiguous with the center hole 160 and two pawl actuation openings 162 are completely spaced apart from and not contiguous with the center hole 160.

Referring to FIGS. 2 and 12, the spacer cam disc 42 may be disposed in the center hole 80 of the gear plate 24 between the first cam plate 38 and the second cam plate 40 and may engage the first cam plate 38 and the second cam plate 40. As such, the spacer cam disc 42 may separate the first cam plate 38 from the second cam plate 40. In addition, the spacer cam disc 42 may be configured to rotate about the axis 18 with respect to the gear plate 24. The spacer cam disc 42 may have a center hole 170, an outer surface 172, and a plurality of slots 174. The center hole 170 may be disposed along the axis 18. The outer surface 172 may be disposed opposite the center hole 170 and may face toward and may engage the gear plate 24. The outer surface 172 may be radially disposed with respect to the axis 18 and may define an outside circumference of the spacer cam disc 42 that may be disposed axially between the first set of teeth 84 and the second set of teeth 86.

The slots 174 may be disposed between the center hole 170 and the outer surface 172. Each slot 174 may generally extend substantially perpendicular to the axis 18 and may receive a pawl pin 134 of a corresponding second pawl 32. As such, the slot 174 may provide clearance for facilitate movement of the pawl pins 134 toward or away from the axis 18.

Referring to FIG. 2, the retainer ring 44 may couple the first plate 20 to the second plate 22. More specifically, the retainer ring 44 may be secured to the first plate 20 but may not be secured to or clamped onto the second plate 22. As such, the second plate 22 and gear plate 24 may be received between the retainer ring 44 and the first plate 20 such that axial movement of the second plate 22 is inhibited while rotational movement of the second plate 22 and gear plate 24 with respect to the retainer ring 44 and first plate 20 may be permitted.

Referring to FIG. 2, the glide 46 may be located between the retainer ring 44 and the second plate 22. The glide 46 may act as a spacer that may separate the second plate 22 from the retainer ring 44. The glide 46 may be configured as a ring and may be made of a polymeric material like nylon.

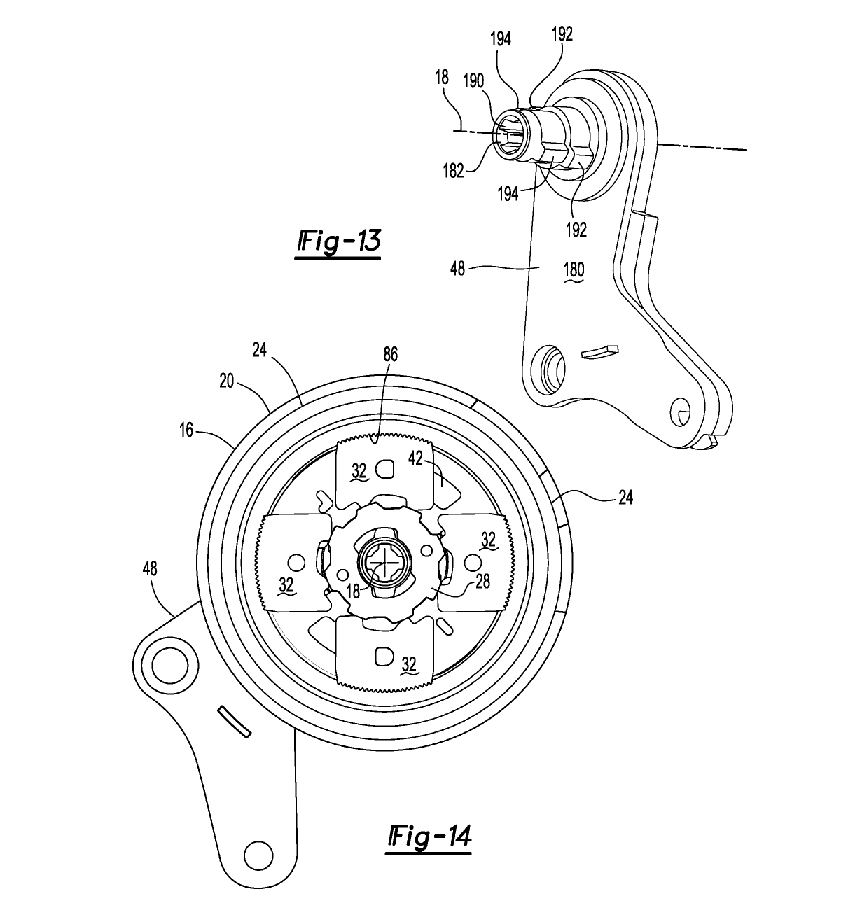

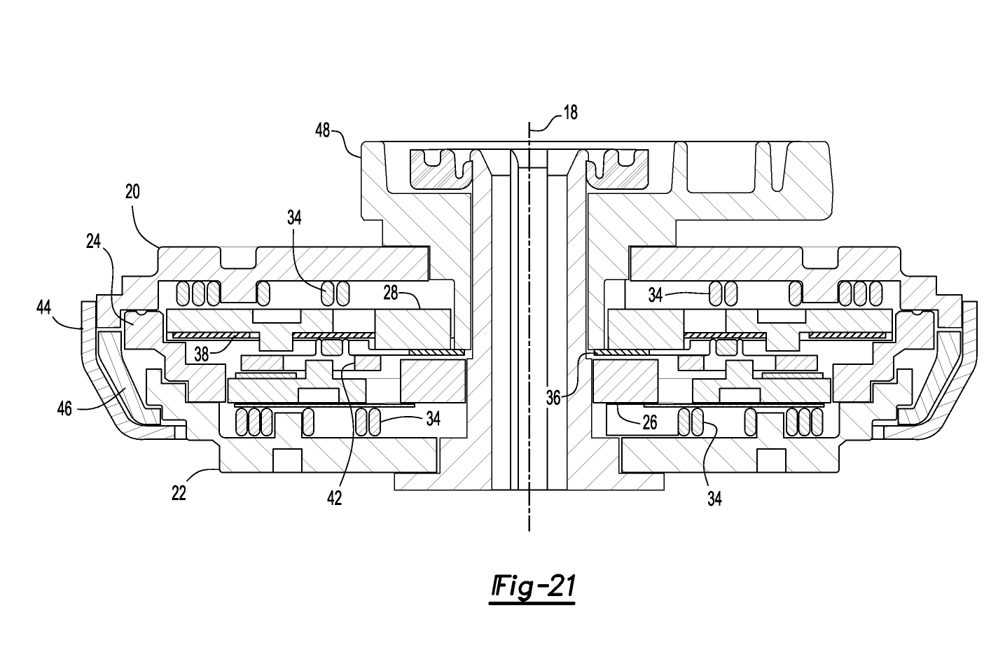

Referring to FIG. 13, the driver 48 may be configured to control actuation of the recliner mechanism 16. In at least one embodiment, the driver 48 may include a body 180 and a hub 182 that may extend along the axis 18 and through recliner mechanism 16. For instance, the hub 182 may extend through the center holes of the first plate 20, the second plate 22, the gear plate 24, the first cam 26, the second cam 28, the cam spacer 36, the first cam plate 38, the second cam plate 40, and the spacer cam disc 42. The driver 48 may be configured to rotate in the first direction and in the second direction about the axis 18. Rotation of the driver 48 may actuate the first set of pawls 30 or the second set of pawls 32 as will be discussed in more detail below. In at least one embodiment, the hub 182 may include a hole 190, a first cam engagement feature 192, and a second cam engagement feature 194. Alternatively, the driver 48 may be configured with a split hub configuration to separate operation of the recline and dump functions as shown in FIG. 21. In such a configuration, interlocks may be provided to inhibit the simultaneous opening or unlocking of the dump function and recliner functions. Moreover, a cable may be provided to remotely release an inboard recliner mechanism 16 from an outboard side of the seat assembly 10.

The hole 190 may be defined by the hub 182 and may extend along the axis 18. The hole 190 may be configured to receive a torsion rod that may interconnect recliner mechanisms such that the torsion rod or may not rotate about the axis 18 with respect to the hub 182.

The first cam engagement feature 192 may be configured to engage the first cam 26. For instance, a first cam engagement feature 192 may be disposed in the center hole 100 of the first cam 26. In FIG. 13, a pair of first cam engagement features 192 are shown that may be disposed opposite each other and that may extend from an external surface of the hub 182 that may be disposed opposite the hole 190. The first cam engagement features 192 may extend radially from the hub 182 and may be axially disposed between the body 180 of the driver 48 and the second cam engagement feature 194.

The second cam engagement feature 194 may be configured to engage the second cam 28. For instance, a second cam engagement feature 194 may be disposed in the center hole 110 of the second cam 28. In FIG. 13, a pair of second cam engagement features 194 are shown that may be disposed opposite each other and that may extend from an external surface of the hub 182 that may be disposed opposite the hole 190. The second cam engagement features 194 may extend radially from the hub 182 and may be axially disposed between the first cam engagement features 192 and an end of the hub 182. In addition, each second cam engagement feature 194 may be axially aligned with a first cam engagement feature 192 but may have an outer surface that may be disposed closer to the axis 18 than the outer surface of the first cam engagement feature 192. As such, the second cam engagement feature 194 may be generally smaller than the first cam engagement feature 192 and may not engage or actuate the first cam 26.

Referring to FIG. 2, the cap 50 may secure the driver 48 to the recliner mechanism 16. The cap 50 may configured as a ring that may be disposed proximate the center hole 70 of the second plate 22 and may engage or be coupled to the hub 182 of the driver 48. As such, the cap 50 may inhibit axial movement of the driver 48 while permitting the driver 48 to rotate about the axis 18.

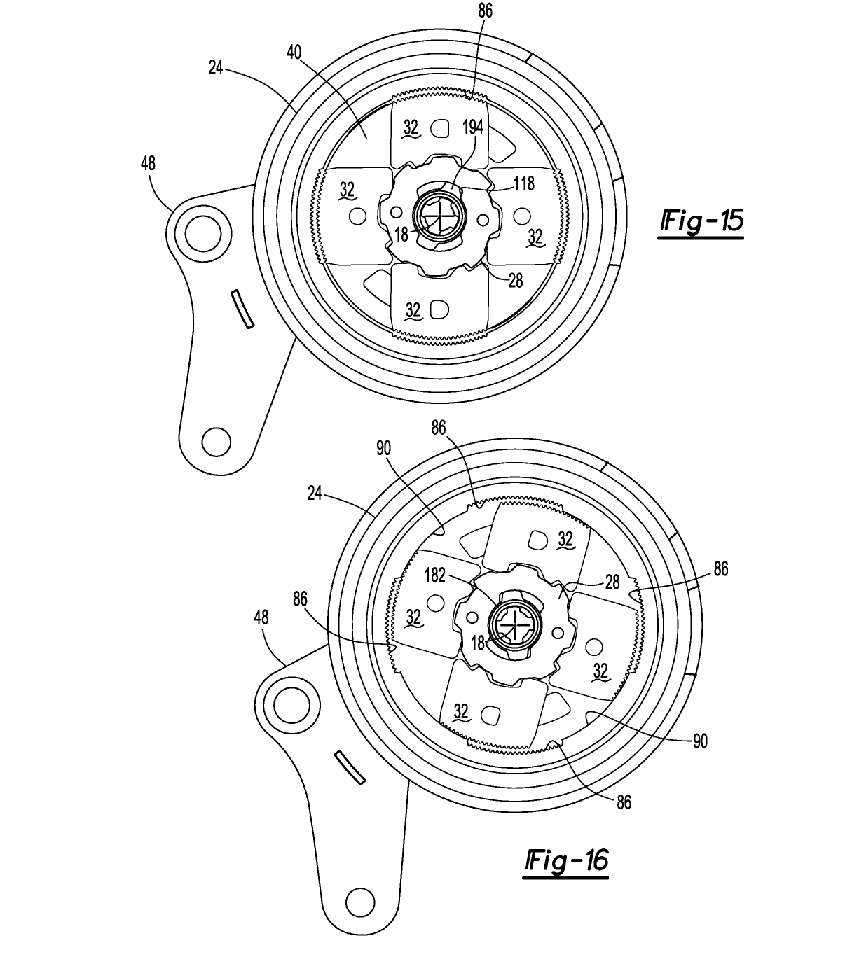

Operation of the recliner mechanism will now be described in more detail. First, the seat back dump function and operation of the second pawls 32 will be discussed with reference to FIGS. 14-16. In these Figures, the recliner mechanism 16 is viewed from the left end of FIG. 2 without the cap 50, retainer ring 44, glider 46, second plate 22, and springs 34 associated with the second set of pawls 32 for clarity.

In FIG. 14, the recliner mechanism 16 is shown in a locked position. In the locked position the members of the second set of pawls 32 may engage the second set of teeth 86 on the gear plate 24 thereby inhibiting rotation of the gear plate 24 about the axis 18 and with respect to the second plate 22.

In FIG. 15, rotation of the driver 48 in a clockwise direction about the axis 18 from the perspective shown may rotate the second cam 28. More specifically, sufficient rotation of the driver 48 may cause the second cam engagement features 194 to engage the second side surface 118 of the second cam 28 and rotate the second cam 28 in a clockwise direction about the axis 18 from the perspective shown. Rotation of the second cam 28 in a clockwise direction may rotate the second cam plate 40. Rotation of the second cam plate 40 in a clockwise direction may cause the second set of pawls 32 to retract or move toward the axis 18. As such, the second set of pawls 32 may disengage the second set of teeth 86 on the gear plate 24, thereby allowing the seat back 14 to fold forward as represented by the rotation shown in FIG. 16. Accordingly, the second plate 22 and the second set of pawls 32 may rotate together about the axis 18 with respect to the first plate 20 and the gear plate 24 when the second set of pawls 32 is disengaged from the second set of teeth 86 of the gear plate 24 while the first set of pawls 30 may engage the first set of teeth 84 such that the gear plate 24 does not rotate about the axis 18 with respect to the first plate 20.

In the position shown in FIG. 16, the second set of pawls 32 engage the separating surface 90 of the gear plate 24, thereby inhibiting movement of the second set of pawls 32 away from the axis 18 so long as the second set of pawls 32 are not aligned with the subgroups of the second set of teeth 86. As such, the second cam 28 cannot be rotated counterclockwise from the perspective shown, and since the hub 182 would engage the second cam 28 before engaging the first cam 26 rotation of the first cam 26 to the retracted position would be inhibited. More specifically, the width of the slot in the second cam 28 between the first side surface 116 and the second side surface 118 may limit the range of motion of the hub 182. As such, the members of the first set of pawls 30 and members of the second set of pawls 32 cannot be opened simultaneously or simultaneously disengage the gear plate 24 (i.e., the members of the first set of pawls 30 cannot be disengaged from the first set of teeth 84 at the same time that the members of the second set of pawls 32 are disengaged from the second set of teeth 86), thereby preventing an out of sync condition between the recliner side (first set of pawls 30/first set of teeth 84) and the dump side (second set of pawls 32/second set of teeth 86) of the recliner mechanism 16. The pawls 32 may return to the locked position under the biasing force of the spring 34 when the pawls 32 are aligned with the second set of teeth 86 and when the hub 182 is released.

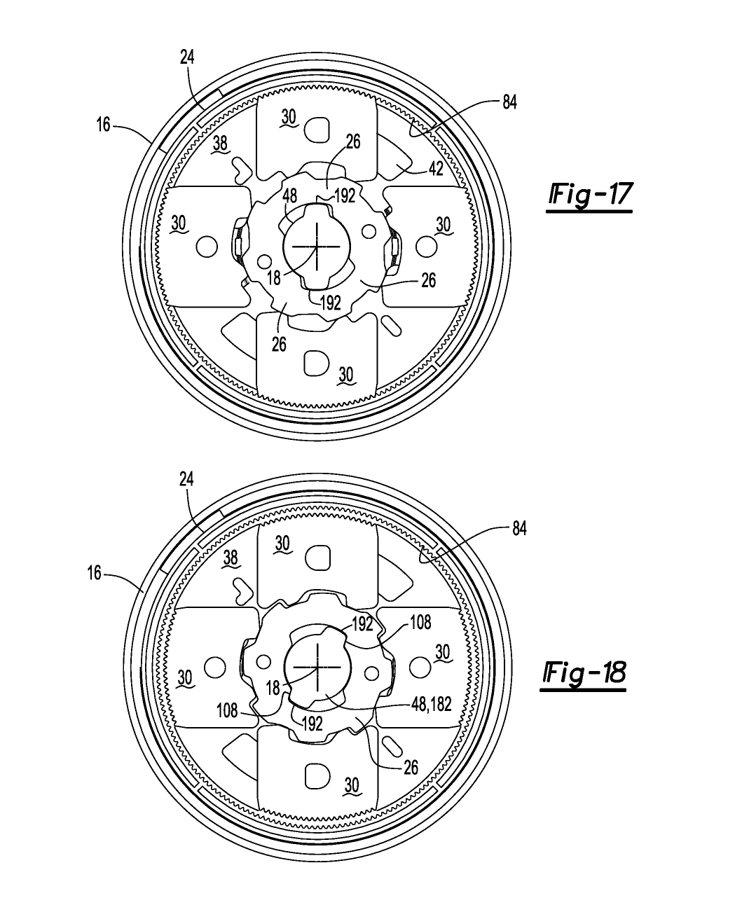

Referring to FIGS. 17 and 18 seat back recliner functionality of the recliner mechanism is shown. In these Figures, the recliner mechanism 16 is viewed from the right end of FIG. 2 or in the opposite axial direction as compared to FIGS. 14-16, without the body 180 of the driver 48, first plate 20, and springs 34 associated with the first set of pawls 30 for clarity.

In FIG. 17, the recliner mechanism 16 is shown in a locked position. In the locked position the members of the first set of pawls 30 may engage the first set of teeth 84 on the gear plate 24, thereby holding the seat back to inhibit reclining about the axis 18.

In FIG. 18, rotation of the driver 48 in a first direction about the axis 18 or a clockwise direction from the perspective shown may rotate the first cam 26. It is noted that rotation of the driver 48 in the clockwise direction from the perspective shown would be rotation on a counterclockwise direction from the perspective shown in FIGS. 14-16. More specifically, sufficient rotation of the driver 48 may cause the first cam engagement features 192 to engage the second side surface 108 of the first cam 26 and rotate the first cam 26 in a clockwise direction about the axis 18 from the perspective shown. Rotation of the first cam 26 in a clockwise direction may rotate the first cam plate 38. Rotation of the first cam plate 38 in a clockwise direction from the perspective shown may cause the first set of pawls 30 to retract or move toward the axis 18. As such, the first set of pawls 30 may disengage the first set of teeth 84 on the gear plate 24, thereby allowing the seat back 14 to recline. Accordingly, the gear plate 24 and the second plate 22 may rotate about the axis 18 with respect to the first plate 20 when the first set of pawls 30 is disengaged from the first set of teeth 84 while the second plate 22 and the second set of pawls 32 may not rotate about the axis 18 with respect to the gear plate 24 due to engagement of the second set of pawls 32 with the second set of teeth 86 of the gear plate 24. The pawls 30 may return to the locked position under the biasing force of the spring 34 when the hub 182 is released.

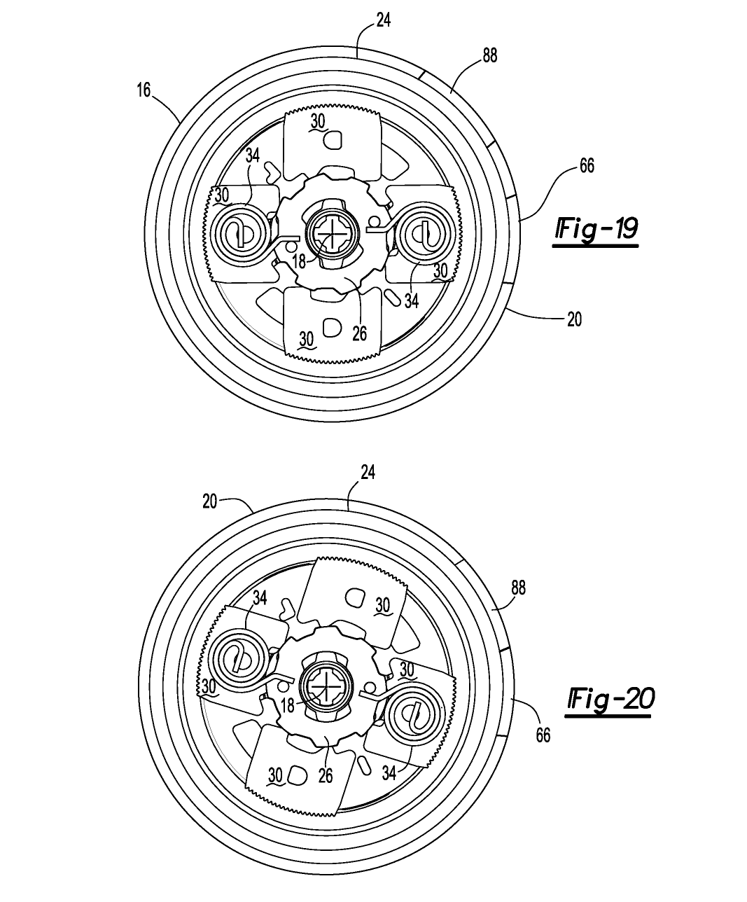

Referring to FIGS. 19 and 20, operation of the recliner comfort stops is shown. FIGS. 19 and 20 are viewed from the same perspective as FIGS. 14-16 without the cap 50, retainer ring 44, glider 46, second plate 22, and driver 48 for clarity. The comfort stops may be provided with a seat assembly having easy entry functionality. More specifically, comfort stops may act as a forward stop mechanism or limit the forward rotation of the seat back when the recliner mechanism is in use, thereby preventing easy entry function activation and potential loss of memory of the last adjusted position of the recliner mechanism.

In FIG. 19, the recliner mechanism 16 is shown in a design position or nominal seating position in which the seat may be occupied. In the design position, the first plate stop tab 66 on the first plate 20 may be spaced apart from and may not engage the gear plate stop tab 88 on the gear plate 24.

In FIG. 20, the recliner mechanism 16 is shown with the gear plate 24 rotated clockwise about the axis 18 such that the seat back 14 may be in a partially folded forward position. In this position, the gear plate stop tab 88 on the gear plate 24 is moved into engagement with the first plate stop tab 66 on the first plate 20, thereby inhibiting further clockwise rotation of the seat back 14 and gear plate 24 about the axis 18 with respect to the first plate 20 since the first plate 20 may be fixedly positioned with respect to the seat bottom 12 and therefore may not rotate about the axis 18. Engagement of the first plate stop tab 66 and the gear plate stop tab 88 may not inhibit rotation of the dump mechanism/forward dump folding of the seat back 14 or rotation of the second plate 22 with respect to the gear plate 24.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A recliner mechanism comprising:
a first plate;
a second plate that is configured to rotate about an axis with respect to the first plate;
a gear plate that is disposed between the first plate and the second plate and that is configured to rotate with respect to the first plate and the second plate, the gear plate having a first set of teeth disposed proximate the first plate and a second set of teeth that is disposed proximate the second plate;
a first set of pawls that are configured to engage the first set of teeth to inhibit rotation of the gear plate with respect to the first plate; and
a second set of pawls that are configured to engage the second set of teeth to inhibit rotation of the second plate with respect to the gear plate.

2. The recliner mechanism of claim 1 wherein first set of pawls and the second set of pawls do not simultaneously disengage the gear plate.

3. The recliner mechanism of claim 1 wherein the gear plate does not rotate about the axis with respect to the first plate when the first set of pawls engages the first set of teeth and wherein the second plate and second set of pawls rotate together about the axis with respect to the first plate and the gear plate when the second set of pawls is disengaged from the gear plate.

4. The recliner mechanism of claim 1 wherein the gear plate and the second plate rotate about the axis with respect to the first plate when the first set of pawls is disengaged from the first set of teeth and wherein the second plate and second set of pawls do not rotate about the axis with respect to the gear plate when the second set of pawls engages the gear plate.

5. The recliner mechanism of claim 4 wherein the first plate has a first plate stop tab and the gear plate has a gear plate stop tab, wherein rotation of the gear plate about the axis with respect to the first plate is inhibited when the first plate stop tab engages the gear plate stop tab.

6. The recliner mechanism of claim 5 wherein the first plate stop tab is disposed proximate an outer surface of the first plate and the gear plate stop tab is disposed proximate an outer surface of the gear plate.

7. The recliner mechanism of claim 6 wherein the first plate stop tab extends axially toward the gear plate and the gear plate stop tab extends toward the first plate.

8. A recliner mechanism comprising:
a first plate;
a second plate that is configured to rotate about an axis with respect to the first plate;
a gear plate that is disposed between the first plate and the second plate and that is configured to rotate with respect to the first plate and the second plate, the gear plate having a first set of teeth and a second set of teeth that at least partially define a center hole of the gear plate;
a first set of pawls that are received in the center hole and that are configured to engage the first set of teeth to inhibit rotation of the gear plate with respect to the first plate; and
a second set of pawls that are received in the center hole and that are configured to engage the second set of teeth to inhibit rotation of the second plate with respect to the gear plate, wherein and the second set of pawls is axially disposed closer to the second plate than the first set of pawls.

9. The recliner mechanism of claim 8 wherein the first set of teeth extends continuously around the axis and is disposed further from the axis than the second set of teeth.

10. The recliner mechanism of claim 8 wherein the first set of teeth is completely spaced apart from the second set of teeth.

11. The recliner mechanism of claim 8 wherein the second set of teeth includes a first subgroup and a second subgroup and wherein a separating surface that is free of teeth is disposed between the first subgroup and the second subgroup.

12. The recliner mechanism of claim 11 wherein the second set of pawls is inhibited from engaging the second set of teeth when a member of the second set of pawls engages the separating surface.

13. The recliner mechanism of claim 11 wherein the separating surface is disposed at a substantially constant radial distance with respect to the axis.

14. The recliner mechanism of claim 11 wherein the separating surface is disposed closer to the axis than the first set of teeth and the second set of teeth.

15. A recliner mechanism comprising:
a first plate;
a second plate that is configured to rotate about an axis with respect to the first plate;
a gear plate that is disposed between the first plate and the second plate and that is configured to rotate with respect to the first plate and the second plate, the gear plate having a first set of teeth and a second set of teeth that at least partially define a center hole of the gear plate;
a first set of pawls that are received in the center hole and that are configured to engage the first set of teeth to inhibit rotation of the gear plate with respect to the first plate;
a first cam plate that is disposed in the center hole and that is configured to actuate the first set of pawls;
a second set of pawls that are received in the center hole and that are configured to engage the second set of teeth to inhibit rotation of the second plate with respect to the gear plate; and
a second cam plate that is disposed in the center hole and that is configured to actuate the second set of pawls.

16. The recliner mechanism of claim 15 wherein the first cam plate is disposed between the first set of pawls and the second set of pawls and is configured to actuate the first set of pawls when the first cam plate is rotated about the axis.

17. The recliner mechanism of claim 15 wherein the second cam plate is disposed between the second set of pawls and the first cam plate and is configured to actuate the second set of pawls when the second cam plate is rotated about the axis.

18. The recliner mechanism of claim 15 further comprising a spacer cam disc that is disposed in the center hole between the first cam plate and the second cam plate.

19. The recliner mechanism of claim 18 further comprising a first cam that is disposed in the center hole that rotates the first cam plate and a second cam that is disposed in the center hole that rotates the second cam plate.

20. The recliner mechanism of claim 19 further comprising a driver that actuates the first cam when the driver rotates about the axis in a first direction and that actuates the second cam when the driver rotates about the axis in a second direction that is disposed opposite the first direction.
